(19) United States
(12) Patent Application Publication
(10) Pub. No.: US 2007/0292062 A1
(43) Pub. Date: Dec. 20, 2007

(54) Spherical bearing assembly and hinge mechanism for same

(75) Inventors: Robert Arnold, Little Torch Key, FL (US); Dhananjay Bhatt, Laguna Hills, CA (US)

Correspondence Address: MICHAUD-DUFFY GROUP LLP, 306 INDUSTRIAL PARK ROAD, SUITE 206, MIDDLETOWN, CT, 06457, US

(73) Assignee: Roller Bearing Company of America, Inc., Oxford, CT (US)

(21) Appl. No.: 11/698,352

(22) Filed: Jan. 26, 2007

Related U.S. Application Data
(60) Provisional application No. 60/763,186, filed on Jan. 26, 2006.

(51) Int. Cl. F16C 23/08

(52) U.S. Cl. 384/206

(57) ABSTRACT

A bearing assembly for a hinge mechanism is described. The hinge couples a first component and a second component. The bearing assembly includes a ball, an outer ring, a pin and a fastener. The ball includes a bore at a center axis and a convex outer surface. The outer ring includes an outer surface affixed within the second component and a concave surface in rolling contact with the ball to define a primary slip path. The pin is located within the center bore. The pin is affixed to first and second outside surfaces of the fork. The fastener secures the pin such that the bearing assembly permits rotation of the outer ring and the second component along the primary slip path. A secondary slip path is defined by the ball rotating about the pin. The secondary slip path is engaged when rotation about the primary slip path fails.

### CROSS-REFERENCE TO RELATED APPLICATIONS

This patent application claims benefit under 35 U.S.C. §119(e) of copending, U.S. Provisional Patent Applications, Ser. No. 60/763,186, entitled “High Lift System,” filed Jan. 26, 2006, the disclosure of which is incorporated by reference herein in its entirety.

### BACKGROUND OF THE INVENTION

1. Field of the Invention

This invention relates to spherical bearing assemblies and, more particularly, to a concentric spherical bearing assembly for movably coupling a first member to a second member. In one embodiment, the concentric spherical bearing assembly is included in a hinge assembly such as, for example, a lift-assisting hinge assembly of an aircraft.

2. Description of the Related Art

It is well known to use bearings to reduce friction between two moving parts of a mechanical assembly. Similarly, it is well known to use bearings in a hinge assembly movably coupling a first component to a second component. One implementation of such a hinge is within pivotable portions of a wing of an aircraft.

An aircraft is kept airborne by the aerodynamic lift of its wings. Generally speaking, an aircraft wing comprises a main wing and lift-assisting devices (e.g., slats, flaps, spoilers, and the like) fixed to the wing for changing a lift coefficient during take-off and landing of the aircraft. Lift-assisting devices are typically affixed to a leading edge or a trailing edge of the aircraft wing. For example, one such lift-assisting device is a Fowler flap. The Fowler flap is affixed to the trailing edge of the wing to provide a control surface that is moved to the rear and below the trailing edge of the main wing and set at a predetermined angle. In this way the Fowler flap forms an air gap between a top and a bottom surface of the wing to increase an airfoil curvature of the wing while also increasing the surface area of the wing.

FIG. 1 illustrates a conventional aircraft wing arrangement in a retracted state, shown generally at 100, and an extended state, shown generally at 110. The wing arrangement includes a main wing 101 and a Fowler flap 102 affixed to a trailing edge 103 of the main wing 101. In the retracted state 100, the Fowler flap 102 abuts the main wing 101. In order to move the Fowler flap 102 from the retracted state 100 to the extended state 110, a track mechanism 112 moves the Fowler flap 102 first to the rear of the main wing 101 and then folds the flap 102 downward to a position below the main wing 101. In this way an air gap 111 is created between the main wing 101 and the extended Fowler flap 102. As shown in FIG. 1, the Fowler flap 102 is attached to the trailing edge 103 of the main wing 101.

There has been a need to improve the lift performance of an aircraft wing with safer, more reliable components and particularly components of reduced weight and higher maintainability and quality. There has also been a need to improve hinges and bearings used in critical system such as, for example, aircraft control systems.

### SUMMARY OF THE INVENTION

The present invention is directed to a spherical bearing assembly for a hinge mechanism. The hinge mechanism couples a first component and a second component. The first component has a fork section forming a channel between portions of the fork section. The second component has a finger section. The spherical bearing assembly includes a bearing ball, an outer ring, a main pin and a fastener. The bearing ball includes a bore at a center axis and a spherically convex outer surface. The outer ring member includes an outer surface affixed within the finger section of second component and a spherically concave inner surface in rolling contact with the outer surface of the bearing ball. The rolling contact defines a primary slip path. The main pin is located within the center bore of the bearing ball.

In one embodiment, a first end of the main pin is located at an first outside surface of the fork section and a second end of the main pin is disposed at a second outside surface of the fork section at an opposing side of the channel. The fastener secures the second end of main pin such that the spherical bearing assembly is located within the channel and permits rotation of the outer ring member and the second component along the primary slip path and about the center axis.

In one embodiment, the outer ring member includes a flange abutting an inner surface of the fork section. The spherical bearing assembly further includes a fuse pin securing the flange to the inner surface of the fork section and inhibiting rotation of the bearing ball about the main pin.

In one aspect of the invention, a secondary slip path is defined by the bearing ball rotating about main pin. The secondary slip path is engaged when rotation about the primary slip path fails and the fuse pin is sheared.

### BRIEF DESCRIPTION OF THE DRAWINGS

The features and advantages of the present invention will be better understood when the Detailed Description of the Preferred Embodiments given below is considered in conjunction with the figures provided.

FIG. 1 illustrates a wing arrangement of an aircraft as is known in the art.

FIG. 2 illustrates a dropped hinge mechanism for a main wing employing a bearing assembly configured and operating in accordance with one embodiment of the present invention.

FIG. 3 is an isometric view of the hinge mechanism of FIG. 2.

FIG. 4 is an enlarged, partially cross-sectional view of an Area 4 of FIG. 3 taken along a hinge axis.

FIG. 5 is a partial isometric view of the spherical bearing assembly and dropped hinge mechanism of FIG. 2.

FIG. 6 is a cross-sectional view illustrating a bearing ball and race of the spherical bearing assembly of FIG. 5.

FIG. 7 is an isometric view of the spherical bearing assembly configured and operating in accordance with one embodiment of the present invention.

FIG. 8 is a plan view of the spherical bearing assembly of FIG. 7.

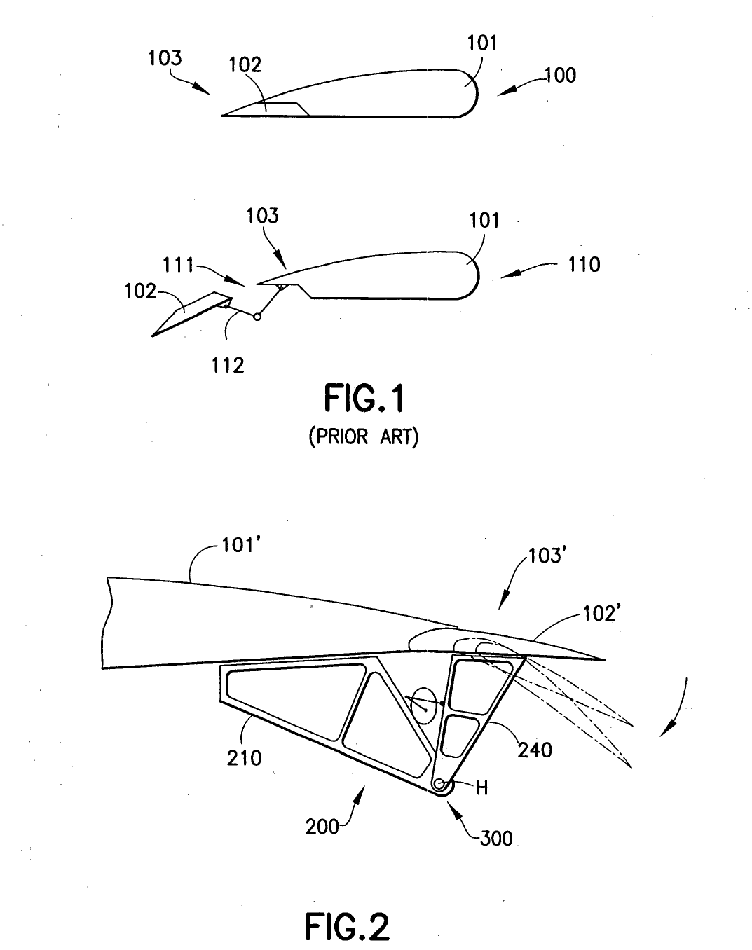

In these figures like structures are assigned like reference numerals, but may not be referenced in the description of all figures.

### DETAILED DESCRIPTION OF THE PREFERRED EMBODIMENTS

The following detailed description of the invention refers to the accompanying drawings. While the detailed description may refer to the invention used to improve a particular aspect of aircraft design, assembly and maintenance, the detailed description is not intended to limit the scope of the present invention. Rather, the scope of the invention is defined by the appended claims and equivalents.

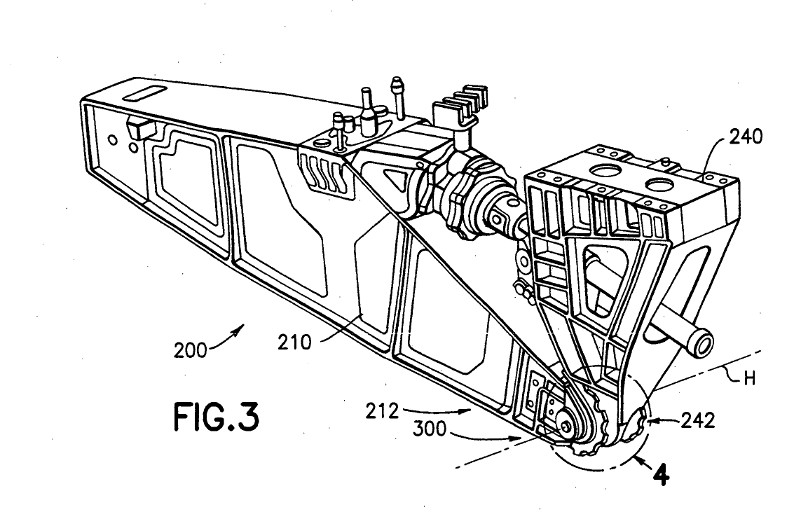

As noted above, various improvements to the Fowler flap, air gap manipulation and kinematic solutions for the same, are well known. For example, U.S. Patent Application Publication No. 2006/0202089, published Sep. 14, 2006, entitled “Aircraft wing, method for operating an aircraft wing, and use of a pivotable trailing edge on a main wing of an aircraft, for adjusting the shape and width of an air gap,” by Daniel Reckzeh et al. (Reckzeh et al.) discloses such improvements. In particular, Reckzeh et al. are seen to disclose a dropped hinge mechanism for supporting a Fowler flap and improvements in performance and aerodynamic characteristics thereof. The disclosure of the Reckzeh et al. patent publication is incorporated by reference herein in its entirety. FIG. 2 illustrates, in a simplified form, a dropped hinge mechanism 200 of Reckzeh.

As shown in FIG. 2, the dropped hinge mechanism 200 is affixed to a trailing edge 103′ of a main wing 101′ of an aircraft (not shown) for controlling a lift-assisting device such as, for example, a flap 102′. In one embodiment, the dropped hinge mechanism 200 includes a support beam 210 coupled to the main wing 101′, a support lever 240 coupled to the flap 102′ and a concentric spherical plain self-lubricated bearing assembly 300 disposed between and moveably coupling the support lever 240 to the support beam 210. In accordance with the present invention, the spherical bearing assembly 300 allows the support lever 240 and flap 102′ to rotate about a hinge axis H between a retracted and an extended state (shown in dashed lines), as are generally known. FIG. 3 is an isometric view of the dropped hinge mechanism 200 of FIG. 2.

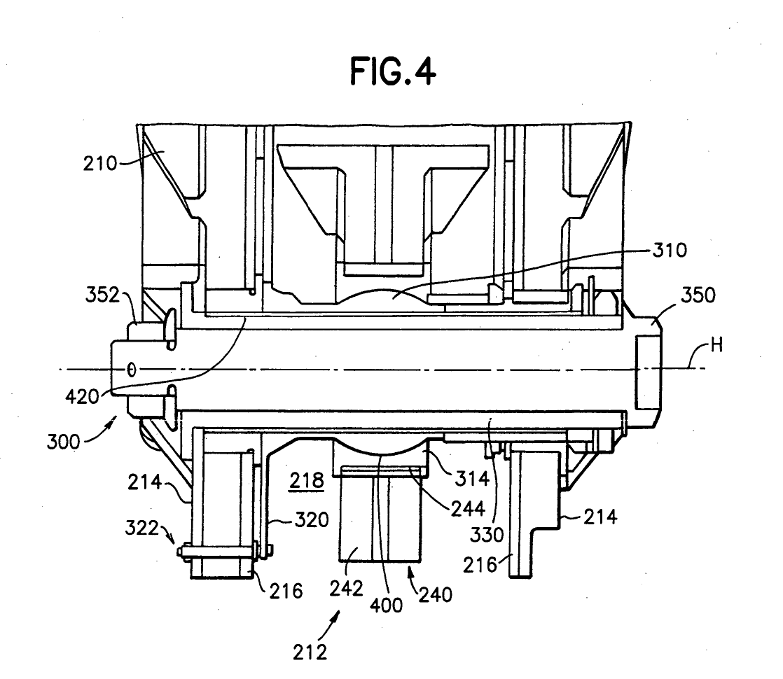

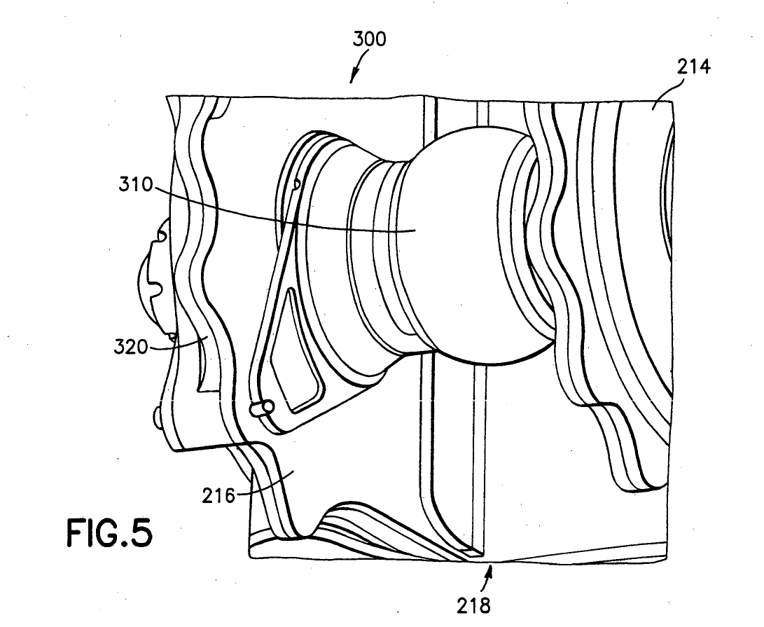

FIG. 4 is an enlarged, partially cross-sectional view of Area 4 of FIG. 3 taken along the hinge axis H. In accordance with the present invention, FIG. 4 details the coupling by the concentric spherical bearing assembly 300 of the support beam 210 and support lever 240 about the hinge axis H. As shown in FIGS. 3-5, the support beam 210 includes a fork section 212 having an outer surface 214 and an inner surface 216. The inner surface 216 of the fork section 212 defines a channel 218 of a width sufficient to receive the spherical bearing assembly 300 (FIG. 5). The support lever 240 includes a finger section 242 extending within the channel 218 of the fork section 212. The finger section 242 includes a bore 244 dimensioned to receive an outer surface of the spherical bearing assembly 300, as described below.

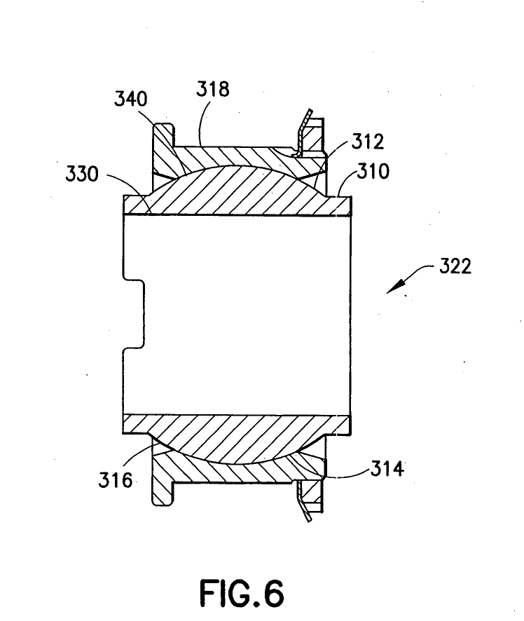

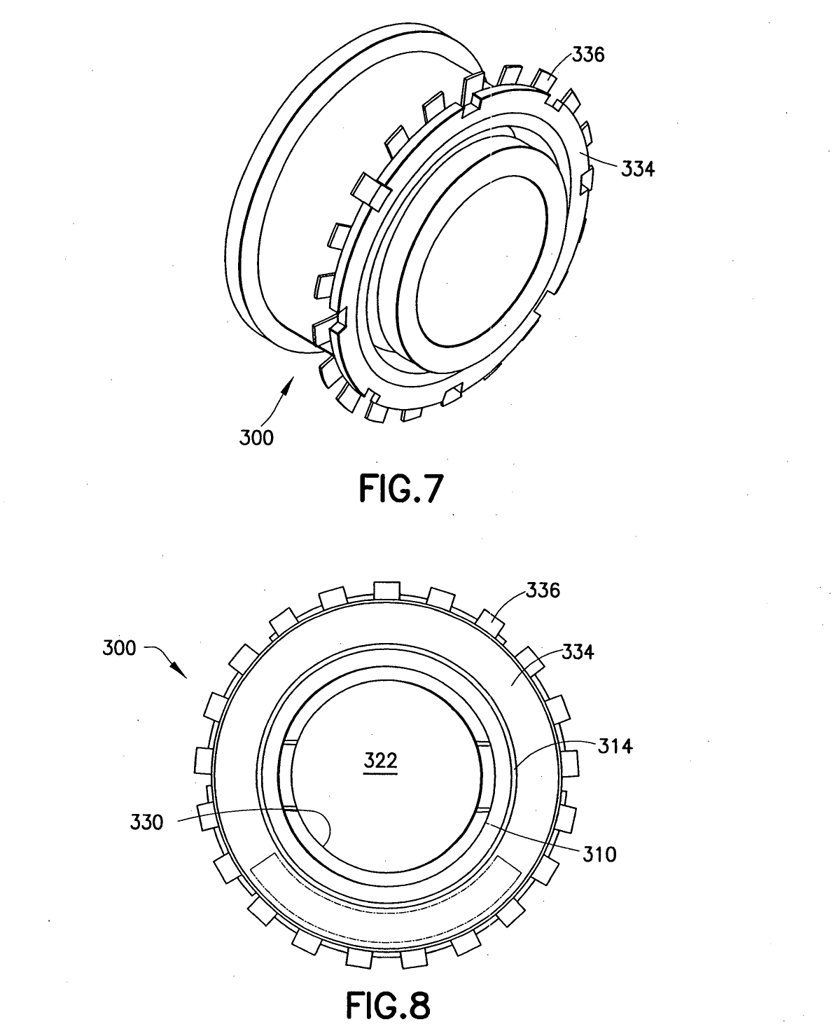

FIGS. 6-8 illustrates the spherical bearing assembly 300 in accordance with one embodiment of the present invention. The spherical bearing assembly 300 includes a bearing ball 310 in slipping or rolling contact with an outer ring or race 314 along a spherically convex outer surface 312 of the bearing ball 310 and a complimentary spherically concave inner surface 316 of the race 314. FIG. 6 is a cross-sectional view illustrating the bearing ball 310 and race 314 of the spherical bearing assembly. In one embodiment, the spherical bearing assembly 300 includes a flange 320 facilitating coupling of the spherical bearing assembly 300 to the inner surface 216 of the fork section 212 by a pin such as, for example, a fuse pin 322. The race 314 includes an outer surface 318 adapted for engagement (e.g., press fit) within the bore 244 of the finger section 242 of the support lever 240. The bearing ball 310 includes a center bore 322.

A liner 330 is disposed in the center bore 322 (FIG. 4). In one embodiment the liner 330 is comprised of a woven fluorocarbon-based polymer fabric material such as, for example, a PolyTetraFluoroEthylene (PTFE) fabric material. In one embodiment, the woven PTFE fabric material is commercially available under the designation FIBRILOID® (FIBRILOID is a registered trademark of Roller Bearing Company of America, Oxford, Conn.). In one embodiment, a liner 340 such as, for example, a FIBRILOID® liner, is disposed between the spherically convex outer surface 312 of the bearing ball 310 and the complimentary spherically concave inner surface 316 of the race 314. It should be appreciated that the liners 330 and 340 provide the spherical bearing assembly 300 its self-lubricating characteristic. In one embodiment, with the liner 340 disposed between the bearing ball 310 and the race 314, there is no clearance.

A main pin 350 (e.g., a bolt) is disposed within the liner 330 and passes from one outer surface 214 of the fork section 212 to the opposing outer surface 214 of the fork section 212. A fastener 352 (e.g., a nut) secures the main pin 350 within the fork section 212, thus securing the spherical bearing assembly 300 within the fork section 212 of the support beam 210. In one embodiment, the spherical bearing assembly 300 includes a locknut 334 used in combination with a lock washer 336 to hold the bearing ball 310 and race 314 in place on the main pin 350.

In one aspect of the invention, a primary slip path, shown generally at 400, is defined by the rotation of the outer ring or race 314 about the bearing ball 310. The primary slip path 400 of the spherical bearing assembly 300 facilitates rotation of the support lever 240 and, thus the flap 102′, about the hinge axis H as the support lever 240 and the flap 102′ are moved between the retracted and extended states as described herein. It should be appreciated, however, that the inventors have discovered that under certain operational conditions, the primary slip path 400 may fail such that rotation of the support lever 240 and the flap 102′ may be inhibited. In accordance with the present invention, the spherical bearing assembly 300 provides a secondary slip path, shown generally at 420, to permit rotation of the support lever 240 and flap 102′ about the main pin 350 in the event that the primary slip path 400 fails, e.g., the race 314 is not able to rotate around the bearing ball 310.

As noted above, the spherical bearing assembly 300 includes the flange 320 secured to the inner surface 216 of the fork section 212 by the fuse pin 322. Under normal operating conditions, e.g., when rotation occurs by means of the primary slip path 400, the fuse pin 322 locks or inhibits rotation of the bearing ball 310. In the case that the primary slip path 400 fails, the locking fuse pin 322 is sheared off, and the bearing ball 310 is allowed to rotate about the main pin 350, e.g., about the secondary slip path 420. It should be appreciate that in accordance with the present invention the motion of the support lever 240 is sufficient to shear the locking fuse pin 322 when rotation about the primary slip path fails. In this regard, the sheared fuse pin 322 is an indicator to, for example, maintenance personnel that the primary slip path 400 has failed.

Exemplary aspects of the performance of the spherical bearing assembly 300 include the following:

| Performance Parameter | Nominal Capability | |
|---|---|---|
| Static Axial Limit Load | 369 | kN |
| Static Axial Ultimate Load | 494 | kN |
| Static Radial Limit Load | 1,718 | kN |
| Static Radial Ultimate Load | 2,320 | kN |

The spherical bearing assembly 300 meets the following exemplary temperature requirements:

| | |
|---|---|
| Operating temperature | −55° C. to +79° C. |
| Equipment not operating | −55° C. to +85° C. |

As is known in the art, other environmental conditions may impact performance of equipment, for example, equipment used on aircraft. For example, low temperature increases the coefficient of friction of bearing products. Altitude (pressure) is of minimal, if any, effect on bearing performance, other than the associated low temperatures existing at high altitude. Fluid and dirt contamination items can affect the performance of bearing products. It should be appreciated that the aforementioned FIBRILOID® liners are, by nature, non-metallic and self-lubricating as well as chemically resistant to fluids typically used in and around aircraft (e.g., de-icing fluid, hydraulic fluid, and the like). Moreover, the spherical bearing assembly 300 will operate reliably in any geographical location and normal environments including marine atmospheres, moisture, tropical temperatures, and soil and dust conditions in the atmosphere. The FIBRILOID® liner material is qualified to the specification AS 81820, as is known in the art.

In one embodiment, the spherical bearing assembly 300 has a weight of about 2.7 kg, and its components are comprised of the following exemplary materials.

| | | Material | |
|---|---|---|---|
| Component | Material | Specification | Heat Treat |
| Race 314 | 17-4 PH | AMS 5643 | COND H1150 |
| | | | Rc 28-38 |
| Ball 310 | 440C | AMS 5630 | Rc 38-51 |
| Locknut 334 | PH 13-8 Mo | AMS 5629 | Rc 38-51 |
| Lockwasher 336 | 304 or equiv. | AMS 5910 | Rc 28-31 |
| | | | ¼ Hard |
| Liners 330 and 340 | FIBRILOID ® | MPS 7-3050 | |

Of note, 17-4 PH is steel comprised of a precipitation-hardening martensitic stainless steel that may comprise about 0.07% carbon; 0.6% manganese; 0.7% silicon; 0.03% sulfur; 0.04% phosphorous; 16% chromium; 4% nickel; 2.8% copper, 0.1% molybdenum; and 0.3% niobium.

In one embodiment, the no load rotational breakaway torque of the spherical bearing 300 when not installed is from about 0.1 Nm to 2.5 Nm.

In one embodiment, the coefficient of friction between the FIBRILOID® liner 340 and the bearing ball 310 is equal to or less than about 0.2 for the entire operating range of conventional aircraft. It should be appreciated that, for the self-lubricated bearing as described herein, the coefficient of friction is a function of the applied load, temperature, and relative “newness” of the bearing. Self-lubricating liner material such as the aforementioned FIBRILOID® material, require a “break-in” to begin the self-lubrication process. The coefficient of friction of an “as new” bearing employing FIBRILOID® liners is approximately 0.15 at room temperature and 34.5 MPa (5,000 psi) stress level. As the bearing begins to operate and the self-lubrication begins, the coefficient of friction will reduce to about 0.06 at room temperature. For PTFE lubricated bearings, the coefficient of friction will reduce as the stress level is increased. The minimum coefficient of friction will be approximately 0.05 at a stress level greater than 69 MPa (10,000 psi) and an elevated temperature 121° C. (250° F.). Generally, sub-zero temperatures will increase the coefficient of friction of self-lubricated materials by a factor of two or more.

One or more embodiments of the present invention have been described. Nevertheless, it will be understood that various modifications may be made without departing from the spirit and scope of the invention. For example, many construction techniques and materials may be utilized. Accordingly, other embodiments are within the scope of the following claims.

What is claimed is:

1. A spherical bearing assembly of a hinge coupling a first component and a second component, the first component having a fork section forming a channel therebetween and the second component having a finger section, the spherical bearing assembly comprising:
a bearing ball having a bore at a center axis of the ball and a spherically convex outer surface;
an outer ring member having an outer surface disposed within the finger section of second component and a spherically concave inner surface in rolling contact with the outer surface of the bearing ball to define a primary slip path;
a main pin disposed within the center bore of the bearing ball; and
a fastener;
wherein a first end of the main pin is disposed at an first outside surface of the fork section and a second end of the main pin is disposed at a second outside surface of the fork section at an opposing side of the channel, and wherein the fastener secures the second end of main pin such that the spherical bearing assembly is disposed within the channel and permits rotation of the outer ring member and the second component along the primary slip path and about the center axis.

2. The spherical bearing assembly of claim 1, wherein the outer ring member includes a flange abutting an inner surface of the fork section, and wherein the spherical bearing assembly further includes a fuse pin securing the flange to the inner surface of the fork section and inhibiting rotation of the bearing ball about the main pin.

3. The spherical bearing assembly of claim 2, wherein a secondary slip path is defined by the bearing ball rotating about main pin, and wherein the secondary slip path is engaged when rotation about the primary slip path fails and the fuse pin is sheared.

4. The spherical bearing assembly of claim 1, including a first liner disposed within the bore of the bearing ball between an inner surface of the bore and an outer surface of the main pin.

5. The spherical bearing assembly of claim 1, including a second liner disposed between the spherically convex outer surface of the bearing ball and the spherically concave inner surface of the outer ring.

6. The spherical bearing assembly of claim 1, including a first liner disposed within the bore of the bearing ball between an inner surface of the bore and an outer surface of the main pin and a second liner disposed between the spherically convex outer surface of the bearing ball and the spherically concave inner surface of the outer ring.

7. The spherical bearing assembly of claim 6, wherein at least one of the first liner and the second liner is comprised of a woven fluorocarbon-based polymer fabric material.
